(19) United States
(12) Patent Application Publication
(10) Pub. No.: US 2021/0110149 A1
(43) Pub. Date: Apr. 15, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masanori YOSHIZUKA, Kanagawa (JP); Shigeru OKADA, Kanagawa (JP); Junichi SHIMIZU, Kanagawa (JP)

(73) Assignee: FUJI XEROX CO., LTD., Tokyo (JP)

(21) Appl. No.: 16/839,793

(22) Filed: Apr. 3, 2020

(30) Foreign Application Priority Data
Oct. 15, 2019 (JP) 2019-188851

(51) Int. Cl. G06K 9/00

(52) U.S. Cl. CPC G06K 9/00442; G06K 2209/01

(57) ABSTRACT

An information processing apparatus includes a processor configured to specify one or more keys corresponding to user information of a user who uses an electronic document, specify, from the electronic document, a first string corresponding to each of the one or more keys, and extract, from the electronic document, a second string corresponding to the first string.

### CROSS-REFERENCE TO RELATED APPLICATIONS

This application is based on and claims priority under 35 USC 119 from Japanese Patent Application No. 2019-188851 filed Oct. 15, 2019.

### BACKGROUND

### (i) Technical Field

The present disclosure relates to an information processing apparatus and a non-transitory computer readable medium.

### (ii) Related Art

A known string extraction technique is such that a key-value relationship is used to extract strings. A concrete example of the technique will be described. First, a key list (also referred to as a key definition file) is generated or selected. For each of the individual keys included in the key list, a first string is specified in an electronic document. Then, a second string is extracted as a string satisfying a predetermined spatial relationship with the first string. Hereinafter, the first string may be referred to as a key string, and the second string may be referred to as a value string.

The string extraction technique using a key-value relationship enables multiple value strings corresponding to multiple keys to be extracted from an electronic document. An image obtained through a reading operation using a scanner is subjected to the optical character recognition (OCR) technique. Thus, an electronic document is generated as text data. Such an electronic document is subjected to the string extraction technique using a key-value relationship, enabling the image to be given ex-post document attributes.

International Publication No. 2008/152823 discloses a technique for searching a document on the basis of a common keyword list and a sectional keyword list. International Publication No. 2008/152823 does not disclose a configuration related to the key-value technique.

In the string extraction technique using a key-value relationship, when users use only their common keys, the individual users fail to obtain string extraction results corresponding to the respective users.

### SUMMARY

Aspects of non-limiting embodiments of the present disclosure relate to a technique which uses the string extraction technique using a key-value relationship and which provides individual users with string extraction results corresponding to the respective users.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to specify one or more keys corresponding to user information of a user who uses an electronic document, specify, from the electronic document, a first string corresponding to each of the one or more keys, and extract, from the electronic document, a second string corresponding to the first string.

### BRIEF DESCRIPTION OF THE DRAWINGS

Exemplary embodiments of the present disclosure will be described in detail based on the following figures, wherein:

FIG. 1 is a diagram illustrating the entire configuration of an information processing system in which an information processing apparatus is incorporated, according to a first exemplary embodiment;

FIG. 2 is a schematic view of a process in which optical character recognition (OCR) data is generated from a paper document;

FIG. 3 is a schematic view of a process in which desired strings are extracted from OCR data and are displayed;

FIG. 4 is a schematic view describing how to extract strings by using a key-value relationship;

FIG. 5 is a schematic view of a flow in which an information processing apparatus obtains a key list;

FIG. 6 is a diagram illustrating an example of how to generate a combined key list;

FIG. 7 is a diagram illustrating a first example of generating a combined key list;

FIG. 8 is a diagram illustrating a second example of generating a combined key list;

FIG. 9 is a diagram illustrating a third example of generating a combined key list;

FIG. 10 is a diagram illustrating an exemplary confirmation image;

FIG. 11 is a diagram illustrating another exemplary confirmation image;

FIG. 12 is a diagram illustrating the entire configuration of an information processing system in which an information processing apparatus is incorporated, according to a second exemplary embodiment; and

FIG. 13 is a diagram illustrating an exemplary edit image.

### DETAILED DESCRIPTION

Exemplary embodiments will be described below on the basis of the drawings.

### Overview of Exemplary Embodiments

Prior to detailed description about the exemplary embodiments, the overview of the exemplary embodiments will be described.

An information processing apparatus according to the exemplary embodiments includes a processor. The processor specifies one or more keys corresponding to user information of a user who uses an electronic document. The processor specifies, from the electronic document, a first string (that is, a key string) corresponding to each of the one or more keys. The processor extracts, from the electronic document, a second string (that is, a value string) corresponding to the first string. That is, the processor extracts strings by using a key-value relationship on the basis of the keys corresponding to user information of a user who uses an electronic document. Thus, for each individual user, value-string extraction results are provided.

In the above configuration, the “processor” is a device which performs information processing, and its concept includes various configurations. This will be described in detail below. The “electronic document” means a document which has been converted into an electronic form, and its concept may include a document obtained by scanning a paper document, and a document generated, for example, through an input operation on a computer. The “user” is typically a person who refers to or checks the content of an electronic document. From a different viewpoint, the “user” is a target used to specify keys. The “user information” is, for example, user identification information including the user name and the user ID, or information indicating user attributes.

In specification of a value string based on a key string, various techniques may be used. For example, the position of a key string on an electronic document is used as a reference, and a value string is specified as a string which satisfies a predetermined spatial relationship. The “spatial relationship” means, for example, a relationship, such as a relationship indicating that an object is positioned in a specific direction, such as the upward, downward, left, or right direction, relative to the reference position, or a relationship indicating that an object is present in a specific distance or a specific area.

In the exemplary embodiments, the processor specifies, from a key list set including multiple keys, a key list corresponding to a user attribute specified from user information. A “key list” is, for example, a list including one or more keys, and is also called a key definition file. The individual keys included in a key list specified from user information may be used as targets of the process described above. Alternatively, the individual keys included in a key list (for example, a combined key list described below) generated from key lists specified from user information may be used as targets of the process described above. The “key list set” is a set including multiple key lists classified in accordance with the user attribute. One user may be associated with one or multiple user attributes.

In the exemplary embodiments, when multiple key lists corresponding to user attributes are specified, the processor specifies a key string corresponding to each key included in the multiple key lists, and extracts the value string corresponding to the key string. Prior to the process of extracting a string by using the key-value relationship, the processor may generate a combined key list by combining the multiple key lists. For example, the preprocessing may cause extraction of duplicate strings to be avoided, or may achieve more sophisticated string extraction. The multiple key lists may be combined actually or logically.

In the configuration described above, a combination rule for combining multiple key lists may include the sum operation, the negation operation, or the product operation. The sum operation is typically called an OR operation. The sum operation causes a combined key list, in which the keys included in each of the key lists are included, to be generated. The negation operation is typically called a NOT operation. The negation operation causes a combined key list, from which prespecified keys are excluded, to be generated. The combination rule may be specified in advance, or may be set adaptively in accordance with a user, their attributes, or the like.

In the exemplary embodiments, the processor specifies a key string corresponding to each of the keys, which are included in the specified key lists and from which the specific keys corresponding to user attributes are excluded. Then, the processor extracts, from an electronic document, a value string corresponding to the key string. This exclusion causes unnecessary string extraction using the specific keys corresponding to user attributes to be avoided. The specific keys are excluded, for example, in such a manner that the combination rule includes the negation operation on the keys.

In the exemplary embodiments, the processor may display, on a display, multiple value strings extracted on the basis of the multiple keys included in multiple key lists. In this case, when the multiple keys include a specific key satisfying an emphasis condition, a second string corresponding to the specific key may be displayed with emphasized representation among the extracted value strings. The “emphasized representation” means that data is represented in such a manner that a user visually recognizes the data more easily than the other data. The display may be built in the information processing apparatus or an apparatus different from the information processing apparatus, or may be a separate display apparatus.

In the configuration described above, an extracted string list indicating a list of strings that are to be displayed may be generated. The “extracted string list” is a list including at least value strings of the pair of the two types of strings, that is, the key strings and the value strings. As a matter of course, the list may include both the key strings and the value strings.

In the exemplary embodiments, the processor may determine whether or not the emphasis condition is satisfied on the basis of the result of a horizontal key survey on the multiple key lists. The “horizontal key survey” means a key survey through two or more key lists among multiple key lists. For example, the “horizontal key survey” may be a survey based on a statistical method. For example, the processor may use duplicate keys, which are included in two or more key lists among multiple key lists, as a specific key satisfying the emphasis condition.

In the exemplary embodiments, the processor generates text data through character recognition on an image generated by scanning a sheet. The text data thus generated through character recognition is the electronic document described above. A scan means an operation for generating an image by using an optical method, and includes a reading operation performed by using a scanner, and an imaging operation performed by using a camera.

In the exemplary embodiments, the processor stores the text data in a storage device. When the text data is modified, the modified text data is stored in the storage device. The processor specifies one or more key strings from the modified text data, and extracts, from the modified text data, value strings corresponding to the key strings. This modification may be performed while the data is stored in the storage device, or may be performed through a terminal to which the text data is obtained from the storage device.

The information processing method performed in the exemplary embodiments may be implemented as a software function. Programs for performing the information processing method are installed in the information processing apparatus over a network or through a portable storage medium. The concept of the information processing apparatus encompasses various computer systems.

### Details of Exemplary Embodiments

### First Exemplary Embodiment

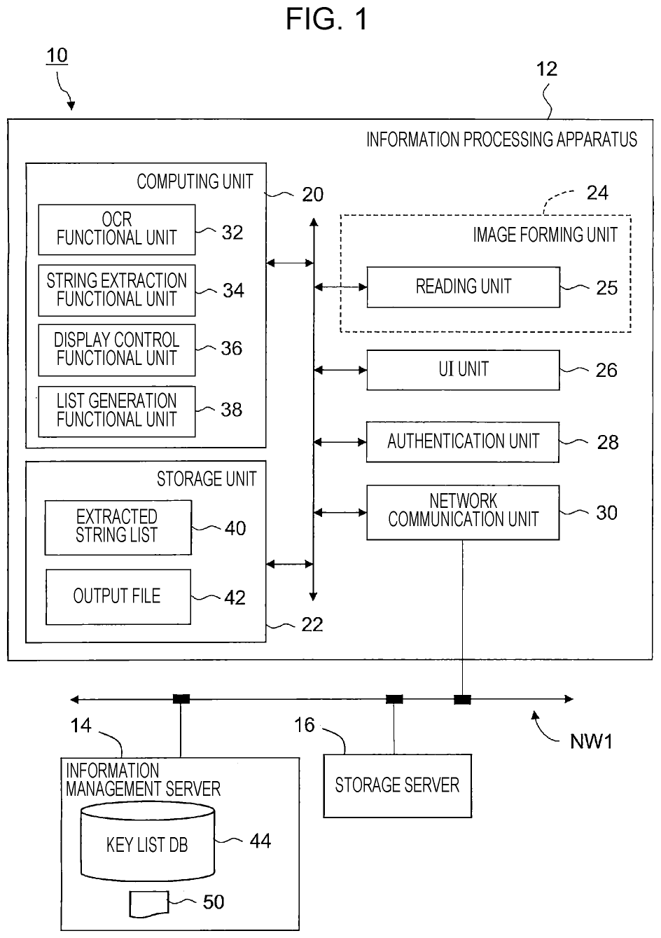

FIG. 1 is a diagram illustrating the entire configuration of an information processing system 10 in which an information processing apparatus 12 is incorporated, according to a first exemplary embodiment. The information processing system 10 includes the information processing apparatus 12, an information management server 14, and a storage server 16. In FIG. 1, the information processing apparatus 12, the information management server 14, and the storage server 16 are connected to each other over a network NW1 constructed in an area such as an office.

The information processing apparatus 12 is a digital multifunction device (a so-called MFP: Multifunction Peripheral) which performs at least one of the print function, the copy function, the scan function, the fax function, and the data transmission function. The information processing apparatus 12 includes a computing unit 20, a storage unit 22, an image forming unit 24, a user interface unit (hereinafter referred to as a UI unit 26), an authentication unit 28, and a network communication unit 30.

The computing unit 20 includes a processor having overall control of the units included in the information processing apparatus 12. The computing unit 20 reads, for execution, information processing programs stored in the storage unit 22, thus functioning as an optical character recognition functional unit (hereinafter referred to as an “OCR functional unit 32”), a string extraction functional unit 34, a display control functional unit 36, and a list generation functional unit 38. These functional units will be described in detail below.

The storage unit 22, which is non-transitory, includes a storage medium which is readable by the computing unit 20. The storage medium is a storage device, such as a hard disk drive (HDD) or a solid state drive (SSD), or a portable medium, such as a magneto-optical disk, a read-only memory (ROM), a compact disc-read-only memory (CD-ROM), or a flash memory. In the example in FIG. 1, the storage unit 22 stores extracted string lists 40 and output files 42 which are described below.

The image forming unit 24 includes a reading unit 25 which scans a sheet and generates an image. For example, the UI unit 26, which is formed of a touch sensor, a display panel, hardware buttons, and the like, receives user input operations and outputs information to users. The authentication unit 28 uses various authentication methods, such as the password authentication, the card authentication, and the biometric authentication, to authenticate a user having a right to use the information processing apparatus 12. The network communication unit 30 is a communication module for performing network communication with external apparatuses including the information management server 14 and the storage server 16.

The information management server 14 stores information (for example, user information, security information, and data management information) necessary for operations on the information processing apparatus 12, and provides the information at appropriate times in response to requests from the information processing apparatus 12. In the information management server 14, a database (hereinafter referred to as a “key list DB 44”) for managing multiple key lists 50 described below is constructed. Each key list 50 is defined for each user or each user attribute. Examples of the user attribute include the section, the department, the job title, the job grade, the team, the project, the task force, and the organization (for example, the company or the group).

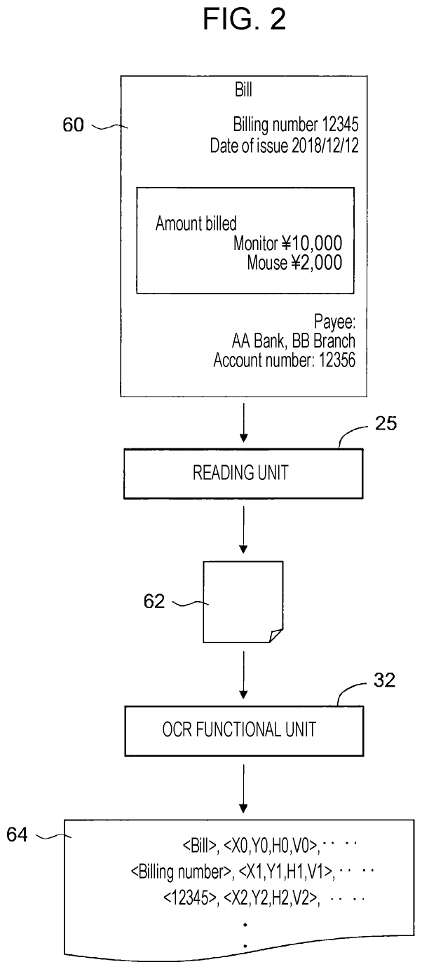

The storage server 16 is a file server for sharing data among users in an area. In the example in FIG. 1, the storage server 16 stores the extracted string lists 40 and the output files 42 generated by the information processing apparatus 12. Each output file 42 is, for example, a data file which has a vector format (for example, PDF: Portable Document Format) and which includes OCR data 64 (FIG. 2).

FIG. 2 is a schematic view of a process in which the OCR data 64 is generated from a paper document 60. The paper document 60 is a paper medium document generated for business, and is, for example, a contract document, an estimate sheet, a purchase order, or a bill. The reading unit 25 of the information processing apparatus 12 scans the paper document 60, and outputs raster-format image data (hereinafter referred to as an “image 62”). After that, the OCR functional unit 32 of the computing unit 20 included in the information processing apparatus 12 performs OCR processing on the image 62 generated by the reading unit 25, and thus outputs the OCR data 64 including the result of this process.

The OCR data 64 is, for example, text data whose unit is constituted by a string indicating a series of characters, position information indicating the position of the string, and other character information. Examples of the “string” include “Bill”, “Billing number”, and “12345”. The “position information” indicates, for example, the coordinates and the lengths of the sides with which the position of a rectangular area surrounding a string may be specified. Examples of “other character information” include the character size and font. The data format of the OCR data 64 is not limited to this. For example, the OCR data 64 may be a data file formed of multiple layers provided for the respective information types.

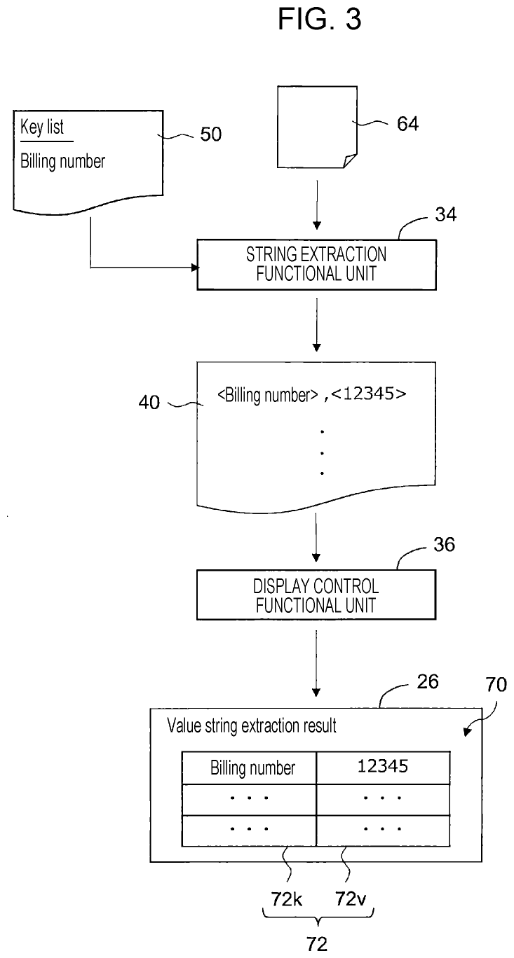

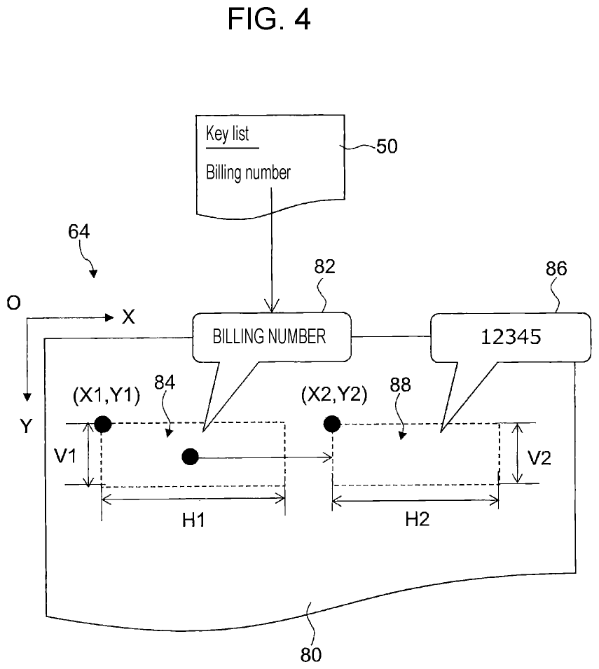

FIG. 3 is a schematic view of a process in which desired strings are extracted for display from the OCR data 64. The string extraction functional unit 34 of the computing unit 20 uses a key list 50, including one or multiple keys, to extract strings in the OCR data 64. Strings are extracted by using a key-value relationship described in detail below by using FIG. 4. This process causes the extracted string list 40, whose unit of information is a pair of a key string and a value string, to be output.

After that, the display control functional unit 36 of the computing unit 20 uses the extracted string list 40, which is generated by the string extraction functional unit 34, to generate display data for displaying a confirmation image 70. Thus, the UI unit 26 of the information processing apparatus 12 displays the confirmation image 70 on the basis of the display data generated by the string extraction functional unit 34. The confirmation image 70 includes a result field 72 in which the extracted string list 40 is represented visibly. The result field 72 includes a key field 72k indicating a list of key strings, and a value field 72v indicating a list of value strings.

FIG. 4 is a schematic view describing how to extract strings by using the key-value relationship. In the OCR data 64, a two-dimensional area 80 in which an electronic document is present is defined by using the XY coordinates system. In the OCR data 64, a string 82, “Billing number”, is associated with position information, (X1, Y1, H1, V1). In this example, (X1, Y1) indicates the coordinates of the top-left vertex of a rectangular area (hereinafter referred to as an arrangement area 84) surrounding the string 82. H1 indicates the length of the side in the X-axis direction of the arrangement area 84. V1 indicates the length of the side in the Y-axis direction of the arrangement area 84. In the OCR data 64, a string 86, “12345”, is associated with position information, (X2, Y2, H2, V2). In this example, (X2, Y2) indicates the coordinates of the top-left vertex of a rectangular area (hereinafter referred to as an arrangement area 88) surrounding the string 86. H2 indicates the length of the side in the X-axis direction of the arrangement area 88. V2 indicates the length of the side in the Y-axis direction of the arrangement area 88.

Under the assumption described above, the string extraction functional unit 34 will be described specifically. The string extraction functional unit 34 selects “Billing number” among the keys included in the key list 50. The string extraction functional unit 34 specifies the string 82, which matches a key (that is, the billing number), from the OCR data 64, and also specifies the arrangement area 84 corresponding to the string 82. The string extraction functional unit 34 specifies the arrangement area 88 satisfying the predetermined spatial relationship with respect to the arrangement area 84. For example, a representative point (in this example, the center of the arrangement area 84) of the arrangement area 84 is used as a starting point to perform scanning in the X-axis forward direction. The arrangement area 88, which is first detected, is selected. Thus, as a value string corresponding to the string 82, “Billing number”, (that is, a key string), the string 86, “12345”, is extracted. When two or more keys are included in the key list 50, a value string is extracted for each of the keys sequentially. The process described above is a known technique as which various methods are used practically.

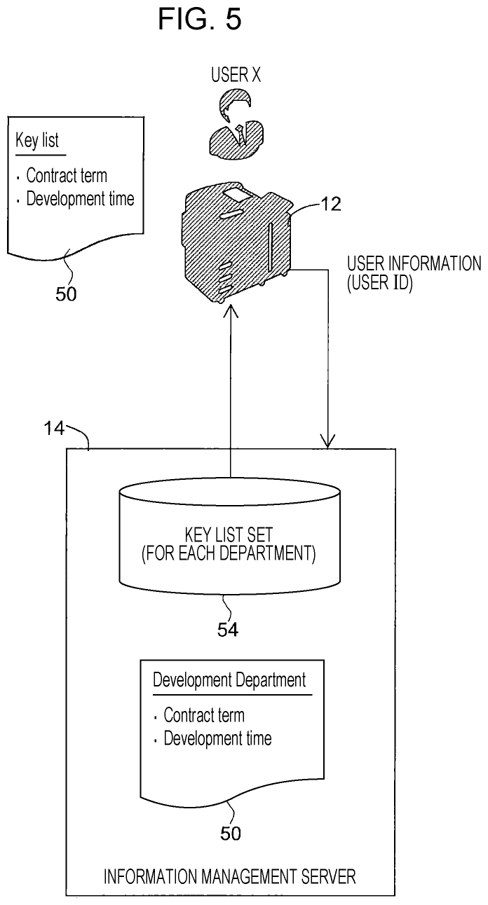

FIG. 5 is a schematic view of a process in which the information processing apparatus 12 obtains a key list 50. The authentication unit 28 of the information processing apparatus 12 obtains user information (for example, the user ID) through an authentication process on user X. After that, the information processing apparatus 12 transmits a request signal, including the user ID, to the information management server 14 in response to a scanning operation on the paper document 60. Then, the information management server 14 uses the user ID, which is obtained from the information processing apparatus 12, to specify that the department, to which user X belongs, is “Development Department”. The information management server 14 selects a key list 50 corresponding to Development Department, from a key list set 54 having key lists for the respective departments, and transmits the key list 50 to the information processing apparatus 12. Thus, the key list 50 corresponding to user X is obtained.

The example described above assumes the case in which one key list 50 is specified for one user. Actually, an individual user has various attributes. Multiple key lists 50 may be specified for a certain user. In the first exemplary embodiment, in this case, instead of a process in which the multiple key lists 50 are processed individually, preprocessing for combining the key lists 50 is used. A combined key list 52 generated through the preprocessing is used in the string extraction process.

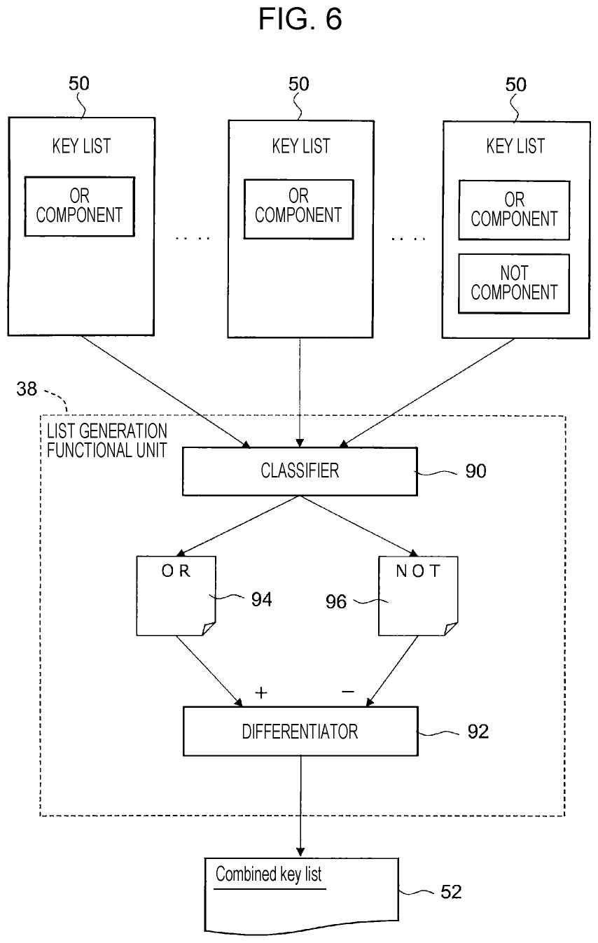

FIG. 6 is a diagram illustrating an exemplary method of generating the combined key list 52. Each key list 50 includes “OR component” keys used in the OR operation, and/or “NOT component” keys used in the NOT operation. The list generation functional unit 38 of the computing unit 20 included in the information processing apparatus 12 generates a single combined key list 52 by combining multiple key lists 50. The list generation functional unit 38 is implemented, for example, by using a classifier 90 and a differentiator 92.

The classifier 90 classifies the keys included in the multiple key lists 50. For example, the classifier 90 may classify the keys into OR components and NOT components in accordance with determination as to whether or not a discriminative flag has been given to each key in the key lists 50 or in accordance with the value of the discriminative flag of each key. Thus, an OR component list 94, in which OR component keys are integrated, and a NOT component list 96, in which NOT component keys are integrated, are output. The key list 50 on the right in FIG. 6 includes both “OR component” keys and “NOT component” keys. Instead of this, a key list 50 including only “NOT components” may be used.

The classifier 90 may perform a horizontal key survey across the multiple key lists 50 in addition to the classification described above. In the key survey, various methods including a statistical approach are used. For example, a histogram is obtained as a survey result. In this case, the OR component list 94 or the NOT component list 96 may include the count values (that is, the frequencies of the histogram) corresponding to the respective keys.

The differentiator 92 obtains the difference between a first key set formed of the OR component list 94 and a second key set formed of the NOT component list 96. Thus, the combined key list 52 including a differential set of keys is generated. The combined key list 52 may include information (for example, the count values described above or the like) necessary to make a determination about the emphasis condition described below.

The generation method illustrated in FIG. 6 is exemplary. Another generation method may be used. For example, instead of including the operation rule in a key list, the operation rule is given in a different way. In this case, the operation rule may be selected adaptively in accordance with a user attribute. A user may specify the operation rule in advance or as occasion demands. The initial setting of the operation rule may be set to the OR operation. When necessary, an optional operation rule may be added to the initial operation rule.

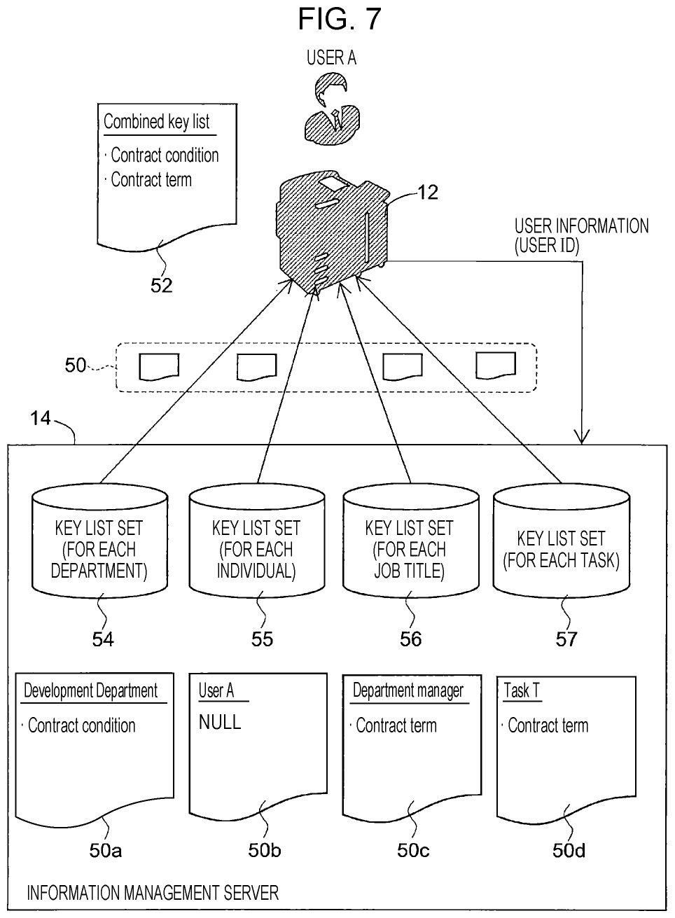

Concrete examples of generating the combined key list 52 from four types of key list sets 54 to 57 will be described by referring to FIGS. 7 to 10. Like the example in FIG. 5, the key list set 54 is a set of key lists 50 classified in accordance with the departments. The key list set 55 is a set of key lists 50 classified in accordance with the individuals. The key list set 56 is a set of key lists 50 classified in accordance with the job titles. The key list set 57 is a set of key lists 50 classified in accordance with the tasks.

In the example in FIG. 7, a key list 50a for “Development Department” corresponding to user A includes “contract condition” (an OR component key). A key list 50b for “user A” corresponding to user A has the NULL value and includes no keys. A key list 50c for “department manager” corresponding to user A includes “contract term” (an OR component key). A key list 50d for “task T” corresponding to user A includes “contract term” (an OR component key). In this case, the classifier 90 in FIG. 6 generates the OR component list 94 including “contract condition” and “contract term”. As a result, the combined key list 52 including “contract condition” and “contract term” is generated.

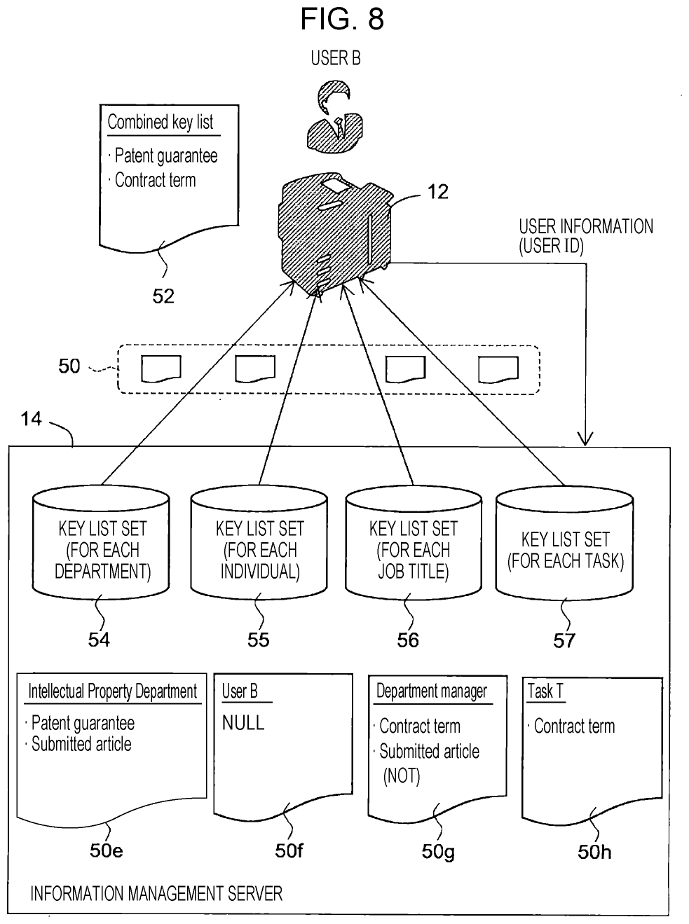

In the example in FIG. 8, a key list 50e for “Intellectual Property Department” corresponding to user B includes “patent guarantee” and “submitted article” (both are OR component keys). A key list 50f for “user B” corresponding to user B has the NULL value and includes no keys. A key list 50g for “department manager” corresponding to user B includes “contract term” (an OR component key) and “submitted article” (a NOT component key). A key list 50h for “task T” corresponding to user B includes “contract term” (an OR component key). In this case, the classifier 90 in FIG. 6 generates the OR component list 94 including “patent guarantee”, “submitted article”, and “contract term”, and the NOT component list 96 including “submitted article”. As a result, the combined key list 52 including “patent guarantee” and “contract term” is generated.

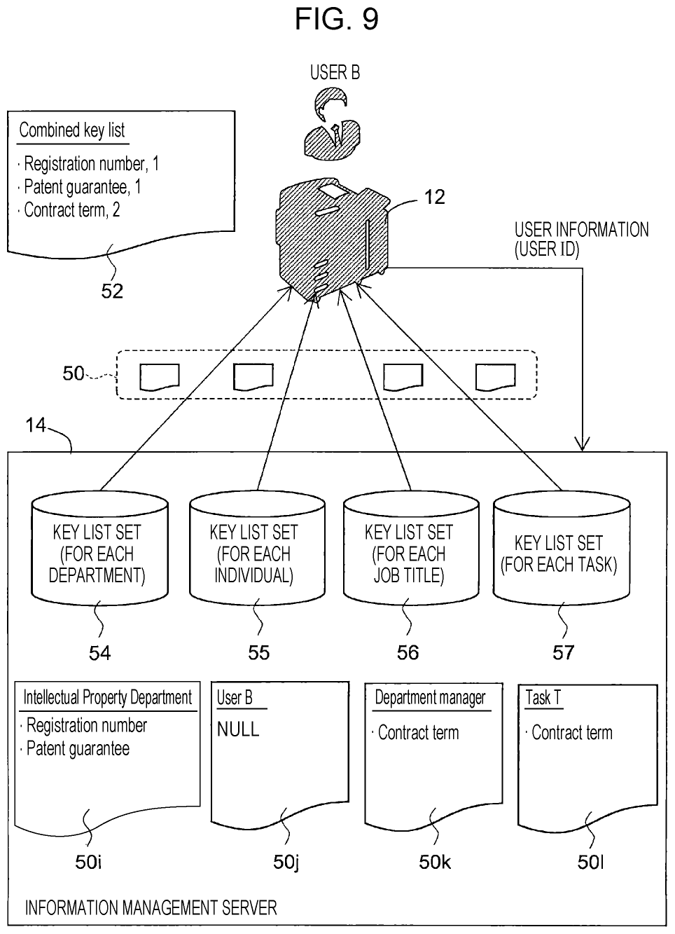

In the example in FIG. 9, a key list 50i for “Intellectual Property Department” corresponding to user B includes “registration number” and “patent guarantee” (both are OR component keys). A key list 50j for “user B” corresponding to user B has the NULL value and includes no keys. A key list 50k for “department manager” corresponding to user B includes “contract term” (an OR component key). A key list 50l for “task T” corresponding to user B includes “contract term” (an OR component key). In this case, the classifier 90 in FIG. 6 generates the OR component list 94 including “registration number” (the count value=1), “patent guarantee” (the count value=1), and “contract term” (the count value=2). As a result, the combined key list 52 including “registration number”, “patent guarantee”, and “contract term” is generated. The combined key list 52 includes, in addition to one or multiple keys, for example, various types of information, such as the count value for each key, a duplicate flag indicating whether or not there are duplicate keys, and attributes given to the key.

There is a higher possibility that a user is interested in information for a key, having a higher count value, in the multiple key lists 50 corresponding to attributes of the user. Therefore, the display control functional unit 36 of the computing unit 20 may display the extracted string list 40 in such a manner that a string satisfying the predetermined emphasis condition is displayed with emphasized representation. An example of the emphasis condition is that the count value described above is absolutely or relatively high. The term “absolutely high” means that the count value is higher than a predetermined threshold. Specifically, the case in which the threshold is one and the count value is two or more, and the case in which the threshold is two and the count value is three or more correspond to the condition. In contrast, the term “relatively high” means that the count value is relatively high in the distribution of the count values. Specifically, the case in which the count value is the maximum, the case in which the count value is in the top 30% in the distribution of the count values in the descending order, and the like correspond to the condition.

Other emphasis conditions include the condition that the duplicate flag has a value indicating “There are duplicate keys,” and the condition that a key attribute is specific. The emphasis condition may be a single condition or a combined condition obtained by combining two or more individual conditions.

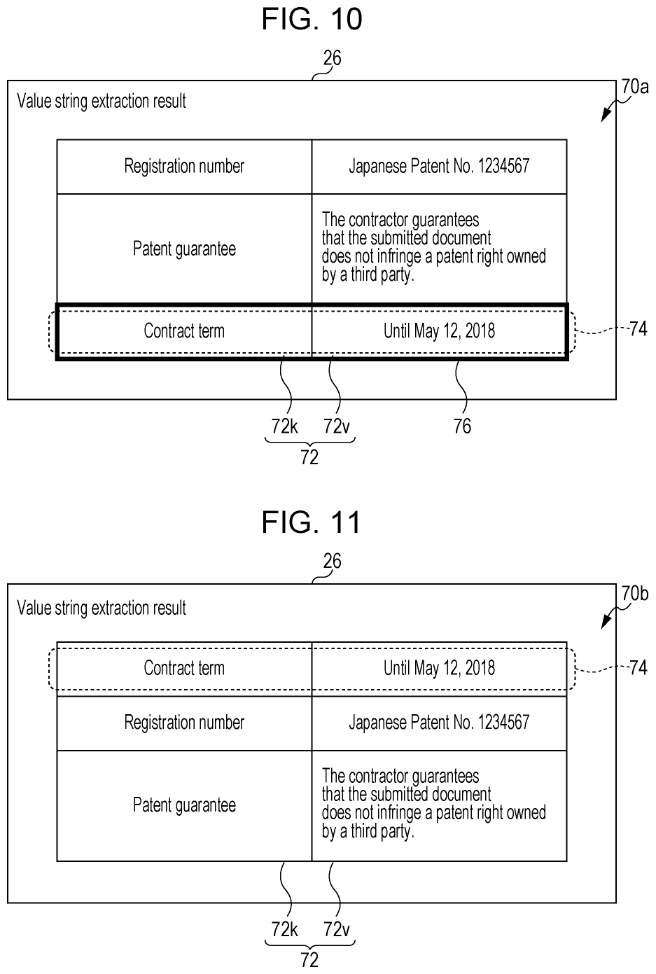

In a confirmation image 70a illustrated in FIG. 10, three key strings, that is, registration number, patent guarantee, and contract term, which are arranged from the top to the bottom, are displayed in the key field 72k of the result field 72. In the value field 72v of the result field 72, three value strings are displayed at the positions corresponding to the respective key strings. The order of this display matches the order obtained in such a manner that the key lists 50i, 50j, 50k, and 50l in FIG. 9 are selected in this sequence, and in which the keys of each list are read from the first to the last.

In the result field 72, a rectangular frame mark 76 is disposed so as to surround a string pair 74 located as the third pair from the top. That is, the string pair 74 corresponding to the key, “contract term”, whose count value is two, is displayed with emphasized representation so that a user visually recognizes the string pair 74 more easily than the other string pairs whose count value is one. The emphasized representation may be made by using a method of providing a specific string pair 74 with a mark, such as a surrounding frame, an underline, or a marking line, or may be made by using a method of changing the color, thickness, size, font, or the like of the string pair 74.

A confirmation image 70b illustrated in FIG. 11 is different from the confirmation image 70a in that the string pair 74 about “contract term” is displayed at the topmost position of the result field 72. That is, the string pair 74 corresponding to the key, “contract term”, whose count value is two, is displayed with emphasized representation so that a user visually recognizes the string pair 74 more easily than the other string pairs whose count value is one. Thus, the string pair 74 may be displayed with emphasized representation by using a method of changing the display position of the string pair 74.

### Second Exemplary Embodiment

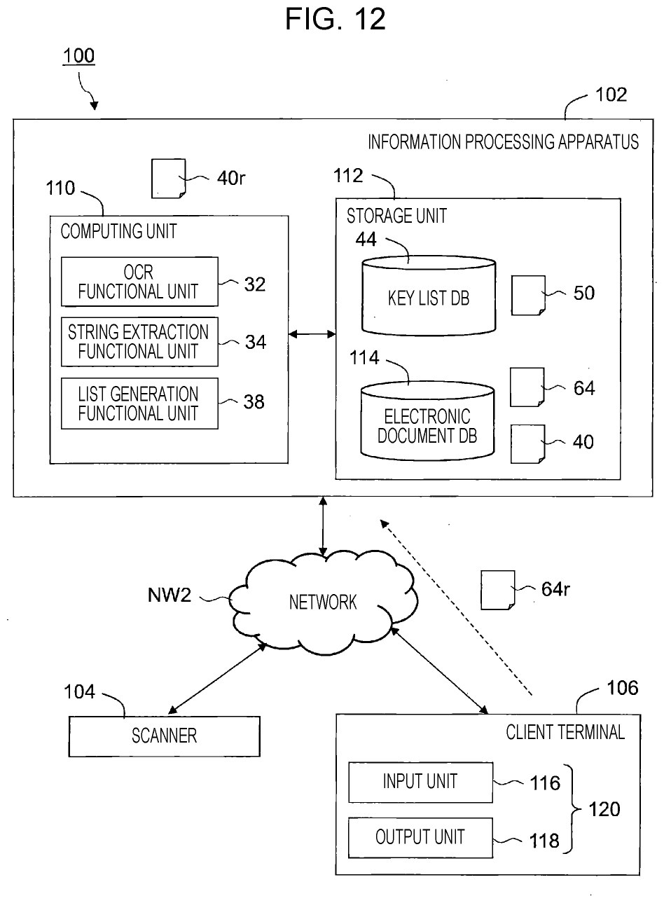

FIG. 12 is a diagram illustrating the entire configuration of an information processing system 100 in which an information processing apparatus 102 is incorporated, according to a second exemplary embodiment. The information processing system 100 includes the information processing apparatus 102, a scanner 104, and a client terminal 106. In FIG. 12, the information processing apparatus 102, the scanner 104, and the client terminal 106 are connected to each other over a network NW2.

The information processing apparatus 102 is a server having a configuration in which various types of processing may be performed on an electronic document. The information processing apparatus 102 may be a cloud server or an on-premises server. FIG. 12 illustrates the information processing apparatus 102 as a single computer. Alternatively, the information processing apparatus 102 may be formed of computers which constitute a distributed system.

The information processing apparatus 102 includes, for example, a computing unit 110 and a storage unit 112. The computing unit 110 includes a processor which controls the units included in the information processing apparatus 102. The computing unit 110 reads, for execution, information processing programs stored in the storage unit 112, functioning as the OCR functional unit 32, the string extraction functional unit 34, and the list generation functional unit 38. These functional units, which are substantially the same as those in the first exemplary embodiment, will not be described in detail.

Like the storage unit 22 in the first exemplary embodiment, the storage unit 112, which is non-transitory, is formed of a storage medium which is readable by the computing unit 110. In the example in FIG. 12, in addition to the key list DB 44 described above, a database (hereinafter referred to as an electronic document DB 114) about electronic documents is constructed in the storage unit 112.

The scanner 104 is an apparatus which generates an image by scanning a sheet. The scanner 104 has a communication function for transmitting an image, which is generated by the scanner 104, to the information processing apparatus 102 over the network NW2.

Examples of the client terminal 106 include a personal computer, a tablet, a smartphone, and a wearable device. The client terminal 106 includes an input unit 116 and an output unit 118. The input unit 116 includes input devices, such as a mouse, a keyboard, a touch sensor, and a microphone. The output unit 118 includes output devices, such as a display and a speaker. The client terminal 106 serves as a user interface unit (hereinafter referred to as a UI unit 120) by combining the input function performed by the input unit 116 and the output function performed by the output unit 118.

The information processing system 100 according to the second exemplary embodiment has the configuration described above. Schematic operations of the information processing system 100 will be described. The scanner 104 scans a sheet in response to a user operation, and generates a paper document image. The scanner 104 transmits the image, which is generated by the scanner 104, to the information processing apparatus 102.

The OCR functional unit 32 of the computing unit 110 included in the information processing apparatus 102 performs OCR processing on the image transmitted from the scanner 104. Thus, the OCR functional unit 32 generates the OCR data 64 including the result of this processing. The string extraction functional unit 34 of the computing unit 110 uses the key list 50, which is read from the key list DB 44, to extract strings in the OCR data 64. Thus, the string extraction functional unit 34 generates the extracted string list 40. After that, the information processing apparatus 102 stores the OCR data 64 and the extracted string list 40, which are generated by the information processing apparatus 102, in the electronic document DB 114 of the storage unit 112.

This enables a user, who has a right for use, to use various data stored in the storage unit 112. For example, the user may operate the UI unit 120 of the client terminal 106. Thus, the user may check the content of an electronic document, and may edit the electronic document when necessary. In this case, the client terminal 106 requests the information processing apparatus 102 to transmit the OCR data 64, and displays the OCR data 64, which is transmitted from the information processing apparatus 102, on the UI unit 120.

When the user edits the OCR data 64 through the UI unit 120, the client terminal 106 transmits modified OCR data 64r to the information processing apparatus 102. Then, the string extraction functional unit 34 of the computing unit 110 included in the information processing apparatus 102 extracts strings on the OCR data 64r transmitted from the client terminal 106. Thus, the string extraction functional unit 34 generates a modified extracted string list 40r. The extracted string list 40r is stored in the storage unit 112. Thus, the user may use correct data reflecting the modification.

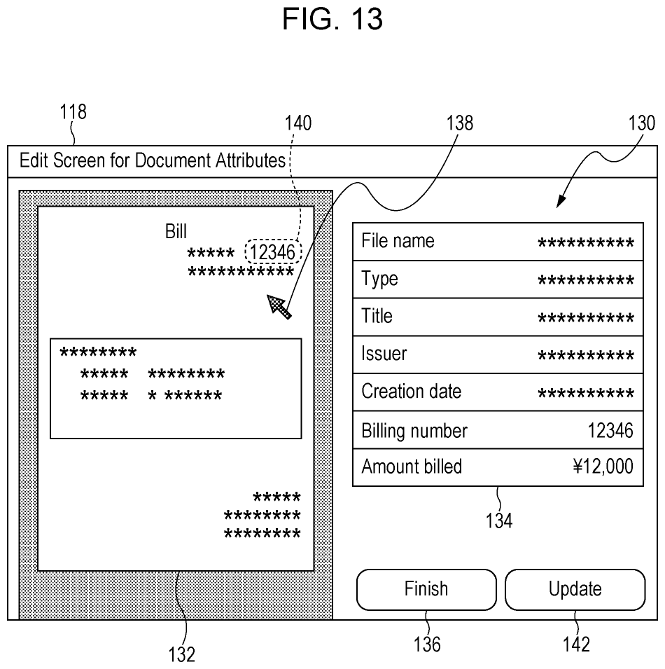

FIG. 13 is a diagram illustrating an exemplary edit image 130. In the edit image 130, a document display field 132 and a document attribute field 134 are arranged side by side in the left-right direction. In the document display field 132, an electronic document, which is an edit target, that is, an estimate sheet in this example, is displayed. In the document attribute field 134, multiple items of the file name, the type, the title, the issuer, the create date, the billing number, and the amount billed are arranged. These items may describe tag information of an electronic document or string pairs included in the extracted string list 40.

A user visually recognizes the document attribute field 134 of the edit image 130, and checks whether or not attributes corresponding to the electronic document displayed in the document display field 132 are provided. When attributes corresponding to the electronic document are provided, the user does not edit the electronic document, and selects a [Finish] button 136. In contrast, for example, when there is an error in the content of the billing number, the user sets a cursor 138 to a position 140 of the value string, “12346”, and uses the function of editing in the document display field 132, to modify the string at the position 140 to “12345”. When the user selects an [Update] button 142, the edit on the OCR data 64 is reflected and the modified OCR data 64r is obtained.

The present disclosure is not limited to the exemplary embodiments described above. As a matter of course, changes may be made freely without departing from the gist of the present disclosure. Alternatively, the configurations may be combined in any way without incurring technical contradictions.

In the exemplary embodiments above, the term “processor” refers to a processor in a broad sense. Examples of the processor include general processors (e.g., CPU: Central Processing Unit and MPU: Microprocessing Unit), and dedicated processors (e.g., GPU: Graphics Processing Unit, ASIC: Application Specific Integrated Circuit, FPGA: Field Programmable Gate Array, and PLD: Programmable Logic Device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

What is claimed is:

1. An information processing apparatus comprising:
a processor configured to
specify one or more keys corresponding to user information of a user who uses an electronic document,
specify, from the electronic document, a first string corresponding to each of the one or more keys, and
extract, from the electronic document, a second string corresponding to the first string.

2. The information processing apparatus according to claim 1,
wherein the processor specifies a key list corresponding to at least one user attribute specified from the user information, from among a key list set including a plurality of keys, and
wherein, for each of the keys in the key list, the processor specifies, from the electronic document, the first string corresponding to the key.

3. The information processing apparatus according to claim 2,
wherein, when a plurality of key lists corresponding to the at least one user attribute are specified, for each of the keys included in the plurality of key lists, the processor specifies the first string corresponding to the key, and
wherein the processor extracts, from the electronic document, the second string corresponding to the first string.

4. The information processing apparatus according to claim 2,
wherein, for each of the keys obtained by excluding a specific key from the keys included in the specified key list, the specific key corresponding to the at least one user attribute, the processor specifies the first string corresponding to the key, and
wherein the processor extracts, from the electronic document, the second string corresponding to the first string.

5. The information processing apparatus according to claim 3,
wherein the processor displays a plurality of second strings on a display, the plurality of second strings being extracted on a basis of a plurality of keys included in the plurality of key lists, and
wherein, when a specific key which satisfies an emphasis condition is included in the plurality of keys, the second string corresponding to the specific key is displayed with emphasized representation among the plurality of second strings which are extracted.

6. The information processing apparatus according to claim 5,
wherein the processor uses, as the specific key, duplicate keys included in two or more key lists among the plurality of key lists.

7. The information processing apparatus according to claim 1,
wherein the processor generates text data through character recognition on an image generated by scanning a sheet, and
wherein the electronic document is text data generated through the character recognition.

8. The information processing apparatus according to claim 7,
wherein the processor stores the text data in a storage device,
wherein, when the text data is modified, the processor stores the modified text data in the storage device,
wherein the processor specifies, from the modified text data, the first string corresponding to each of the one or more keys, and
wherein the processor extracts, from the modified text data, the second string corresponding to the first string.

9. The information processing apparatus according to claim 1,
wherein the second string is a string which satisfies a predetermined spatial relationship with respect to a position of the first string on the electronic document.

10. The information processing apparatus according to claim 9,
wherein the spatial relationship indicates that the second string is positioned in a specific direction with respect to the position of the first string on the electronic document, the specific direction being a direction among directions including upward, downward, right, and left directions.

11. The information processing apparatus according to claim 9,
wherein the spatial relationship indicates that the second string is positioned in a specific distance or a specific area with respect to the position of the first string on the electronic document.

12. A non-transitory computer readable medium storing a program causing a computer to execute a process for information processing, the process comprising:
specifying one or more keys corresponding to user information of a user who uses an electronic document;
specifying, from the electronic document, a first string corresponding to each of the one or more keys; and
extracting, from the electronic document, a second string corresponding to the first string.

13. An information processing apparatus comprising:
means for specifying one or more keys corresponding to user information of a user who uses an electronic document;
means for specifying, from the electronic document, a first string corresponding to each of the one or more keys; and
means for extracting, from the electronic document, a second string corresponding to the first string.
